(19) United States
(12) Patent Application Publication
(10) Pub. No.: US 2004/0078199 A1
(43) Pub. Date: Apr. 22, 2004

(54) Method for auditory based noise reduction and an apparatus for auditory based noise reduction

(76) Inventors: Hanoh Kremer, Herzelia (IL); Hezi Manos, Givataim (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/224,727

(22) Filed: Aug. 20, 2002

(51) Int. Cl. G10L 15/20

(52) U.S. Cl. 704/233

(57) ABSTRACT

An apparatus and a method for speech enhancement, the method includes the steps of: (i) receiving a noisy input signal; (ii) determining whether a likelihood of an existence of a speech signal in the noisy input signal exceeds a first threshold; (iii) generating an estimated noise signal, if the likelihood is below the first threshold; (iv) generating an estimated speech signal by parametric subtraction, if the likelihood exceeds a threshold; and (v) determining a relationship between the estimated noise signal and the estimated speech signal and modifying the estimated speech signal in response to the determination.

### FIELD OF THE INVENTION

The present invention relates to a method for noise reduction based upon the masking phenomenon of the human auditory system, to an apparatus for a noise reduction based upon the masking phenomenon and to a computer readable medium having code embodied therein for causing an electronic device to perform noise reduction based upon the masking phenomenon of the human auditory system

### BACKGROUND

Noise reduction

Corrupted speech signals include clean speech signals and noise signals, such as but not limited to additive noise signals. The noise signal result the transmission, reception, and processing of the clean speech signals. Many telecommunication apparatus and devices are operable to reduce the noise signal by employing noise reduction (also termed speech enhancement) techniques. A telecommunication device include wireless telecommunication devices (such as but not limited to cellular phones), telephones, electrical devices equipped with speech recognition and/or voice reception and processing capabilities and the like.

FIG. 1 illustrates a typical prior art telecommunication device 10 that includes the following components: (i) microphone 11, for converting sound waves to analog electrical signals, (ii) analog to digital converter 12, for converting the analog electrical signals to digital signals, (iii) a speech enhancement entity 13, for implementing speech enhancement techniques. The speech enhancement entity 13 usually includes a combination of hardware and software. The hardware usually includes a processor 14 such as a general purpose microprocessor, a digital signal processor, a tailored integrated circuit or a combination of said processors. The speech enhancement element is also referred in the art as a filter, or an adaptive filter.

Spectral Subtraction

A well known method for noise reduction is known as “spectral subtraction”. Spectral subtraction is based upon two basic assumptions: (i) the speech signal and noise signal are uncorrelated; (ii) the noise signal remains stationary within a predefined time period. In order to confirm the second assumption, spectral subtraction techniques are implemented frame-wise, whereas the frame length is responsive to the predefined time period.

Spectral subtraction involves the steps of: (a) generating a spectral representation of an estimated noise signal; (b) providing a spectral representation of a corrupted speech signal; (c) subtracting the spectral representation of the estimated noise signal from the spectral representation of the corrupted speech signal to provide a spectral representation of an estimated speech signal. Commonly, the spectral representation is generated by a bank of Fast Fourier Transform band pass filters.

The spectral subtraction operation is usually illustrated as a transfer or gain function in the frequency domain. A well known spectral subtraction scheme was offered by Berouti and it is illustrated by the following gain function:

$$\text{a} . G ( ω ) = {( 1 - α \cdot {[ \frac{\vert \hat{D ( ω )} \vert}{\vert Y ( ω ) \vert} ]}^{γ 1} )}^{γ 2} , {IF [ \frac{\vert \hat{D ( ω )} \vert}{\vert Y ( ω ) \vert} ]}^{γ 1} < \frac{1}{α + β}$$

$$\text{b} . G ( ω ) = {( β \cdot {[ \frac{\vert \hat{D ( ω )} \vert}{\vert Y ( ω ) \vert} ]}^{γ 1} )}^{γ 2} , {IF [ \frac{\vert \hat{D ( ω )} \vert}{\vert Y ( ω ) \vert} ]}^{γ 1} \geq \frac{1}{α + β}$$

Whereas α is refereed to as the over-subtraction factor, β is referred to as the spectral flooring and exponent γ1 equals 1/γ2, \hat{D}(ω) is the estimated speech signal and Y(ω) is the noisy input signal.

The Masking Phenomenon of the Human Auditory System

The human auditory system has a frequency response that is characterized by its frequency selectivity and by the masking phenomenon. A well known model of the human auditory system is based upon a partition of the human auditory system spectrum to critical bands. The width of the critical bands increases in a logarithmic manner with frequency.

The masking phenomenon makes a first signal inaudible in the presence of a stronger second signal occurring simultaneously, whereas the frequency of the second signal is near (or even the same as) the frequency of the first signal.

The masking phenomenon is illustrated by two curves 16 and 18 of FIG. 2, the first curve (16) illustrates the human auditory system “absolute” hearing threshold, as signals that fall below the first curve are inaudible. The second curve 18 illustrates that a first signal 17 (for example a 500 Hertz sinusoidal signal) may cause other signals occurring simultaneously to be inaudible, especially at the vicinity of that first signal. The difference between the first curve 16 and the second curve 18 is caused due to the masking phenomenon. The second curve 18 illustrates the masking threshold of the human auditory system at the presence of that first signal.

Noise Reduction Based upon the Masking Phenomenon and Musical Noise

In a article titled “Single Channel Speech Enhancement Based on Masking Properties of the Human Auditory System”, published at IEEE transaction on speech and audio processing, Volume 7, No. 2, from March 1999, Dr. Nathalie Virag suggested a speech enhancement apparatus that utilizes the masking phenomenon. The article is incorporated herein by reference.

The speech enhancement scheme 20 is schematically described in FIG. 3. Scheme 20 includes the following steps: (i) Spectral decomposition of the corrupted signal (illustrated as “Windowing and FFT” block 26), (ii) speech/noise detection (illustrated as “speech/noise detecting” block 22) and estimation of noise during speech pauses (“noise estimation” block 24), (iii) roughly estimating the clean speech signal by reducing the estimated noise from the corrupted signal (“spectral subtraction” block 28), (iv) calculating the masking threshold T(ω) from the roughly estimated clean speech signal (“calculation of masking threshold” block 30), (v) adaptation in time (per frame) and frequency (per band) of the subtraction parameters α and β based upon T(ω) (“optimal weighting coefficients” block 32), (v) calculating the enhanced speech spectral magnitude via parametric subtraction with the adapted parameters β and α (“parametric subtraction” block 34), and inverse transform from the frequency domain to the time domain to provide the enhanced speech signal (“IFFT overlap add” block 36).

Steps (iv) and (v) are based upon the spectral selectivity of the human auditory system and the masking phenomenon. Step (iv) includes the sub-steps of: (iv.a) a frequency analysis along a critical band scale, in which the energies of the estimated clean speech in each critical band are summed; (iv.b) convolution with a spreading function to reflect the masking phenomenon; (iv.c) subtraction of a relative threshold offset, the relative threshold reflects the noise-like nature of speech in higher critical bands and the tone-like nature of speech in lower critical bands; (iv.d) renormalization and comparison to the absolute hearing threshold. It is further noted that Dr. Virag suggests a further modification of the relative threshold by decreasing it for high critical bands.

Errors in the noise estimation result in musical noise. Such error may occur when noise is estimated by calculating its average (either across the whole bandwidth, per critical band or per bin) during speech pauses. Dr. Virag utilizes the exponential averaging technique, in which a noise estimation of a current (m'th) frame depends upon the noise estimations of pervious frames. In mathematical terms:

|Dₘ^{\hat{ }(ω)|}^{y}=λ_{D}*|Dₘ₋₁^{\hat{ }(ω)|}^{y}+(1−λ_{D})*|Yₘ(ω)|^{y}

Whereas λ_{D} is selected in response to the stationarity of the noise, and determines the amount of frames that are taken into account in this averaging, \hat{D}ₘ(ω) is a noise estimate of a (current) m'th frame, \hat{D}ₘ₋₁(ω) is a noise estimation of a previous frame and Yₘ(ω) is an estimation of an input signal that is inputted to the apparatus during a speech pause period.

The musical noise results from differences between the estimated noise signal and the actual noise signal, the latter being characterized by short-term variations. The musical noise appears as tones in random frequencies, whereas these tones may be more troubling that the corrupted speech signal.

Referring back to the subtraction parameters. Over subtraction parameter a is usually greater than 1 thus reflects that the short-time spectral representation of the corrupted speech signal is over-attenuated. This over-attenuation reduces the musical noise but increases the audible distortion of the corrupted speech signal. The spectral flooring parameter β has values that range from zero to positive values that are much smaller than 1. Flooring parameter β masks the musical noise but adds background noise.

Dr. Virag is aware that the rough estimation of the clean speech introduces musical noise. She addresses this problem by modifying the subtraction parameters β and α. If the masking threshold T(ω) is high, the residual noise will be inaudible and subtraction parameters β and a can be kept to their minimal values, in order to minimize distortion. If the masking threshold T(ω) is low, the residual noise will be audible and subtraction parameters β and α must be increased. As the subtraction parameters are calculated on a frame to frame basis, the subtraction parameters of a current (m'th) frame are:

αₘ=F_{α}[αₘᵢₙ,αₘₐₓ,T(ω)]

βₘ=F_{β}[βₘᵢₙ,βₘₐₓ,T(ω)]

whereas αₘᵢₙ, αₘₐₓ, βₘᵢₙ, βₘₐₓ are the minimal and maximal values of α and β accordingly. F_{α} and F_{β} are functions leading to the required noise reduction. Especially: F_{α}=αₘₐₓ, if T(ω)=T(ω)ₘᵢₙ; F_{α}=αₘᵢₙ if T(ω)=T(ω)ₘₐₓ and the values of F_{α} between these two extremes are interpolated based upon the values of T(ω). The same applies for F_{β}. Both functions (F_{β} and F_{α}) are smoothed in order to prevent discontinuities in the gain function G(ω).

Dr. Virag suggests the following values for the mentioned above parameters: αₘᵢₙ=1, αₘₐₓ6, βₘᵢₙ=0, βₘₐₓ=0.02 and γ1=2, γ2=0.5, but further suggests that these values may be changed according to the application.

Additional apparatuses and devices for noise enhancement are mentioned in various U.S patents, such as U.S. Pat. No. 6,415,253 of Johnson, U.S. Pat. No. 6,144,937 of Ali and U.S. Pat. No. 6,175,602 of Gustafsson et al.

U.S. Pat. No. 6,415,253 of Johnson describes a noise suppression device and method in which the noise suppression includes filtering a spectral representation of an input signal by a smoothed Wiener filter, whereas the properties of the smoothed Wiener filter reflect a speech/noise detection.

U.S. Pat. No. 6,144,937 of Ali describes a noise suppression scheme that is based upon the implementation of hierarchical lapped transform, a signal to noise ratio estimation and a musical noise reduction.

U.S. Pat. No. 6,175,602 of Gustafsson et al describes methods and apparatus for providing speech enhancement that use linear convolution, causal filtering and/or spectrum dependent exponential averaging of the spectral subtraction gain function.

### SUMMARY OF THE INVENTION

The invention provides a method and apparatus for speech enhancement as well as a computer readable medium having code embodied therein for causing an electronic device to perform speech enhancement.

The invention provides a method for speech enhancement, the method includes the following steps: (i) receiving a noisy input signal; (ii) determining whether a likelihood of an existence of a speech signal in the noisy input signal exceeds a first threshold; (iii) generating an estimated noise signal, if the likelihood is below the first threshold; (iv) generating an estimated speech signal by parametric subtraction, if the likelihood exceeds a threshold; and (v) determining a relationship between the estimated noise signal and the estimated speech signal and modifying the estimated speech signal in response to the determination.

The invention provides a method for speech enhancement, the method includes the steps of: (i) providing masking thresholds statistics, for each predefined frequency band; the masking statistics being gained by calculating masking thresholds for uncorrupted speech signals; (ii) receiving a noisy input signal, the noisy input signal has at least one frequency component arranged in at least one predefined band; (iii) calculating a masking threshold for each predefined band; (iv) determining subtraction parameters, for each band, in response to the calculated masking threshold and in response to masking threshold statistics; and (v) providing an estimated speech signal by utilizing the determined subtraction parameters.

The invention provides a method for speech enhancement, the method includes the steps of: (i) receiving a noisy input signal; the noisy input signal has at least one frequency component arranged in at least one predefined band; (ii) generating a rough estimation of a speech signal being included in the noisy input signal; (iii) manipulating the rough estimation of speech signal in the frequency domain to provide a manipulated signal that enhances the masking phenomena; (iv) determining subtraction parameters, for each band, in response to the rough estimation of the speech signal and the manipulated signal; and (v) providing an estimated speech signal by utilizing the determined subtraction parameters.

The invention provides a method for speech enhancement, the method includes the steps of: (i) providing noise signal statistics; (ii) providing an estimated minimal noise signal based upon the noise signal statistics; (iii) receiving a noisy input signal, the noisy input signal has at least one frequency component arranged in at least one predefined band; (iv) providing a rough estimation of a maximal speech signal in response to the estimated noise signal and the received noisy input signal; (v) determining subtraction parameters, for each band, in response to (a) the rough estimation of a maximal speech signal; (b) the noisy input signal; and (c) the noise statistics; and (vi) providing an estimated speech signal by utilizing the determined subtraction parameters.

### BRIEF DESCRIPTION OF THE DRAWINGS

Further features and advantages of the invention will be apparent from the description below. The invention is herein described, by way of example only, with reference to the accompanying drawings, wherein:

FIG. 1 illustrates a typical prior art telecommunication device;

FIG. 2 illustrates the masking phenomenon and the absolute hearing threshold;

FIG. 3 illustrates a prior art speech enhancement scheme 20;

FIG. 4 is a schematic description of a apparatus 100 for speech enhancement, in accordance with an embodiment of the invention;

FIGS. 5-7 are flow charts illustrating the calculations of a masking threshold, in accordance with some embodiments of the invention; and

FIGS. 8-11 are flow charts illustrating methods for speech enhancement, in accordance with some embodiments of the invention.

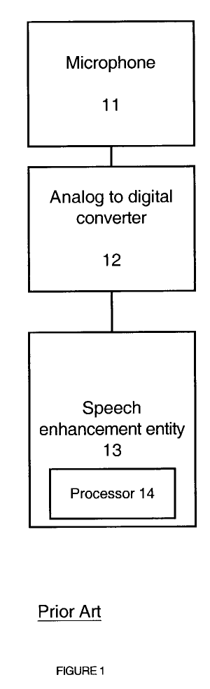

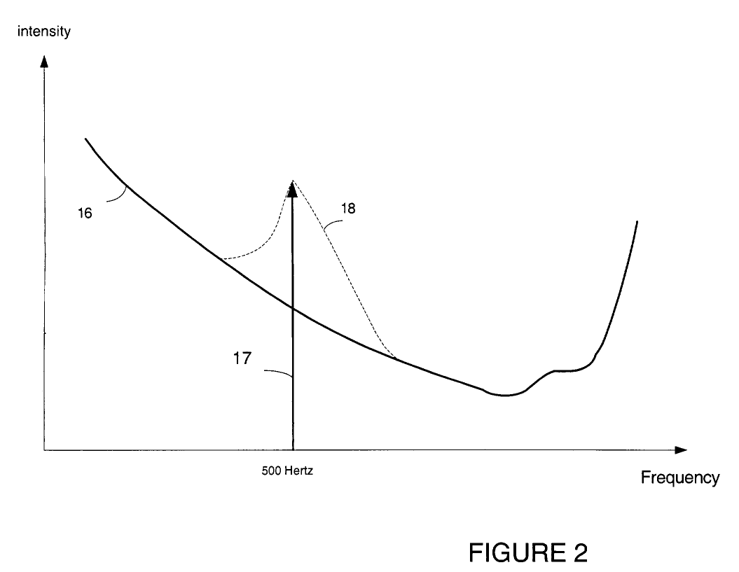

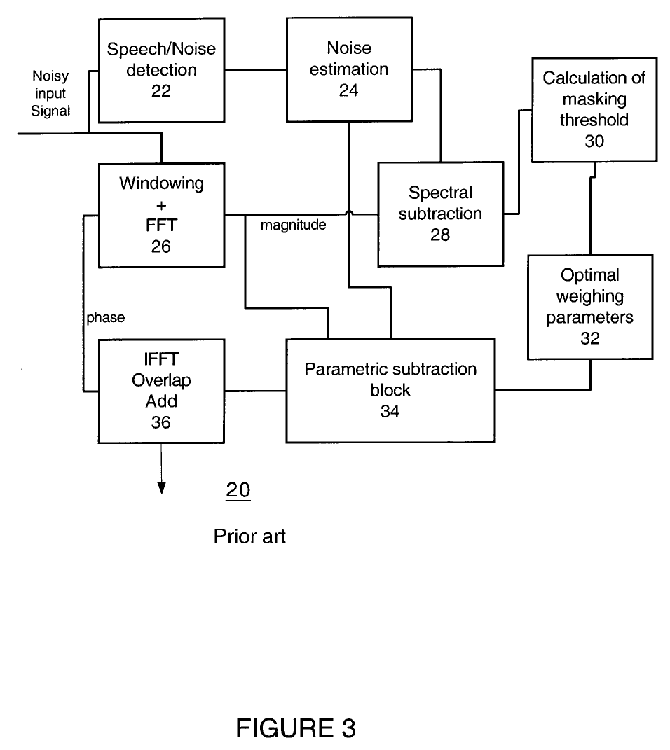

### DETAILED DESCRIPTION

Overall Noise Reduction Scheme

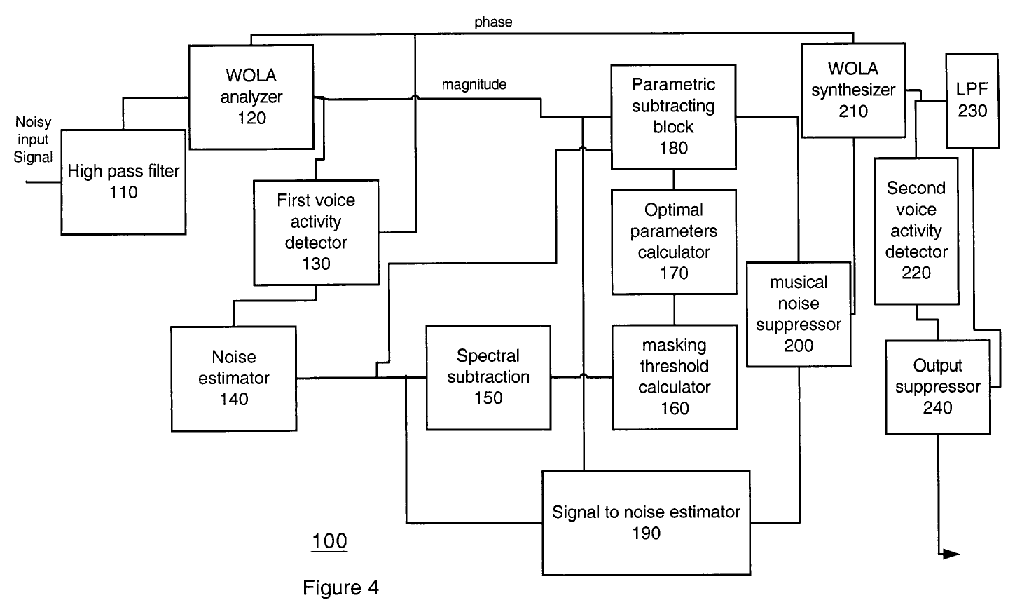

FIG. 4 is a schematic description of apparatus 100 for speech enhancement, in accordance with an embodiment of the invention. Apparatus 100 is illustrated as a combination of blocks, whereas each block may be implemented in hardware and/or software, but conveniently is implemented by software. This software is stored in a memory device that is accessible to a processor, such as a general purpose processor, a digital signal processor, a special tailored processor, or a combination thereof. Accordingly, FIG. 4 may represent software components (procedures, functions) and the interrelationship between the software components.

Apparatus 100 includes: (i) high pass filter 110, (ii) a frequency converter such as Weighted OverLap-Add (WOLA) analyzer 120, (iii) first voice activity detector 130, (iv) noise estimator 140, (v) spectral subtracting block 150, (vi) masking threshold calculator 160, (vii) optimal parameters calculator 170, (viii) parametric subtracting block 180, (ix) signal to noise estimator 190, (x) musical noise suppressor 200, (xi) WOLA synthesizer 210, (xii) second voice activity detector 220, (xiii) low pass filter 230 and (xiv) output suppressor 240. It is noted that the spectral subtracting block 150, the masking threshold calculator 160, the optimal parameters calculator 170, and the parametric subtracting block form a parametric subtraction entity.

The input port of apparatus 100 is the input of the high pass filter 110. The output of the high pass filter is connected to the WOLA analyzer 120. Multiple outputs of WOLA analyzer 120 are connected to various entities, such as the first voice activity detector 130, signal to noise estimator 190 and parametric subtracting block 180. A line denoted “phase” connects WOLA analyzer 120 to WOLA synthesizer 210 thus reflecting that the phase of a corrupted speech signal can estimate the phase of the speech signal. In other words—the speech enhancement process does not take into account phase differences introduced by the additive noise signal.

An output of the first voice activity detectors 130 and an output of second voice activity detector 220 each are connected to noise estimator 140, while the output of the noise estimator 140 is connected to an input of spectral subtracting block 150 and to an input of signal to noise estimator 190. The output of spectral subtracting block 150 is connected to an input of the optical parametric calculator 170 and to the input of the masking threshold calculator 160. The output of the masking threshold calculator 160 is connected to an input of the optimal parameters calculator 170. The output of the optimal parameters calculator 170 is connected to an input of the parametric subtracting block 180. The output of the parametric subtracting block 180 is connected to an input of the musical noise suppressor 200, while another input of the musical noise suppressor 200 is connected to the output of the signal to noise estimator 190. The output of the musical noise suppressor 200 is connected to an input of the WOLA synthesizer 210. The output of the WOLA synthesizer 210 is connected to an input of second voice activity detector 220 and to the input of the low pass filter 230. The output of the low pass filter 230 is connected to an input of the output suppressor 240, while another input of the output suppressor 240 is connected to the output of the second voice activity detector 220. The output of output suppressor 240 provides the output signal of apparatus 100 that is an estimation of the speech signal (during estimated speech periods) or a noise signal (during estimated non-speech periods).

The interrelations between the mentioned above blocks and additional details relating to each block are further illustrated below. Briefly, apparatus 100 is operable to receive a stream of time domain samples of an input signal (being either a corrupted speech signal or only a noise signal), perform a speech enhancement scheme in the frequency domain, and provide a time domain output signal.

Apparatus 100 is adapted to receive a noisy input signal that is sampled at a sampling rate of 8000 Hz, and perform the speech enhancement on a frame-wise basis, whereas each frame includes a sequence of 256 samples, and consecutive frames differ by 64 samples.

According to one aspect of the invention the whenever the first voice activity detector 130 determines (with at least a predefined amount of likelihood) that the noisy input signal does not include a speech signal, the noise signal passes “as is” without being spectrally or parametrically subtracted. According to another aspect of the invention even if the first voice activity detector 130 determines that the noisy input signal does not include a speech signal, the noisy input signal is processed by spectral subtraction and parametric subtraction, to reduce the noise level of the signal outputted from apparatus 100.

High Pass Filter

High pass filter 110, operable to receive a stream of input signals (either corrupted speech signal or noise signals) and perform a high pass filter operation, thus suppressing low frequency spectral components of the input signal. The high pass filtering may be utilized for a reduction of spectral leakage (lower frequency spectral components effect higher frequency spectral components). The spectral leakage results from the short-term processing of signals being implemented during the speech enhancement scheme. As spectral leakage increases as the energy of lower frequency spectral components increase, the high pass filtering reduced spectral leakage.

WOLA Analyzer

WOLA analyzers and WOLA synthesizers are known in the art. The principles of both are illustrated by Crochiere R. E. and Rabiner L at chapter seven of their book “Multirate Digital Signal Processing”, Prentice Hall, 1983, which is incorporated herein by reference.

The high pass filter 110 provides WOLA analyzer 120 a filtered frame of 256 samples. WOLA analyzer 120 filters the 256-long frame by a window, such as a Hanning window to provide a 256-long product frame. The 256-long product frame is split to two 128-long intermediate frames. The two 128-long intermediate frames are summed to provide a 128-long sum frame. The 128-long sum frame is transformed by a Fast Fourier Transform to provide a FFT converted frame that is the spectral representation (also termed spectral composition) of the 128-long sum frame.

For convenience of explanation the FFT converted frame is referred to as the spectral representation of the noisy input frame, although it is actually driven from the noisy input signal after the noisy input signal was high pass filtered, passed through a Hanning window, filtered, split and summed.

The spectral representation of the input signal includes multiple frequency components. The frequency components are located at predefined positions, also known as “FFT bins”. The frequency components are mapped to frequency bands that preferably correspond to the critical bands of the human auditory system.

Assuming that the input signal was sampled at a sampling rate of 8000 Hertz, and that the length of the FFT transform metric is 128 the mapping between the FFT bins, and critical bands, and the frequency are described in the following table:

| Critical | | |
|---|---|---|
| band | FFT bin interval | |
| number | (frequency components) | Real frequencies [Hz] |
| 1 | 1-2 | 0-125 |
| 2 | 3-4 | 125-250 |
| 3 | 5 | 250-312.5 |
| 4 | 6-7 | 312.5-437.5 |
| 5 | 8-9 | 437.5-562.5 |
| 6 | 10-11 | 562.5-687.5 |
| 7 | 12-13 | 687.5-812.5 |
| 8 | 14-15 | 812.5-937.5 |
| 9 | 16-18 | 937.5-1125 |
| 10 | 19-21 | 1125-1312 |
| 11 | 22-24 | 1312-1500 |
| 12 | 25-28 | 1500-1750 |
| 13 | 29-32 | 1750-2000 |
| 14 | 33-38 | 2000-2375 |
| 15 | 39-44 | 2375-2750 |
| 16 | 45-51 | 2750-3187.5 |
| 17 | 52-60 | 3187.5-3750 |
| 18 | 61-64 | 3750-4000 |

First Voice Activity Detector

Various types of voice activity detectors are known in the art. First voice activity detector 130 of FIG. 4 is a cepstral, additive, soft decision voice activity detector, although according to various aspects of the invention other types of voice activity detectors (such as hard decision voice activity detectors, non-additive and/or non-cepstral based voice activity detectors) may be utilized.

The first voice activity detector 130 is additive in the sense that it updates its voice activity detection parameters in response to input signals it classifies as noise signals. According to another aspect of the invention it is further adaptive in the sense that it updates previously calculated statistics and data in response to a second voice activity detector 200 determination indicating that the first voice activity detector 130 was erroneous. The first voice activity detector 130 is a soft-decision in the sense that does not provide a binary decision indicative of whether the input signal includes a speech signal or not but rather is operable to provide an indication of a probability that an input signal includes a speech signal. The first voice activity detector 130 is cepstral in the sense that is bases its decision upon cepstral coefficients and cepstral distance. Cepstral coefficients are driven from an inverse discrete Fourier transform of a logarithm of a short-term power spectrum of the noisy input signal.

A cepstral voice activity detector is operable to compare (i) a cepstral distance and cepstral coefficients of a received noisy input signal to (ii) statistics of cepstral coefficients and cepstral distance of noise signals (e.g.—noisy input signals that were classified as noise).

A description of a cepstral voice activity detector operation principles can be found at following article, that is incorporated herein by reference: that is Petr Pollak, Pavel Sovka and Jan Uhlir, in their article “Cepstral Speech/Pause Detectors”, Proceedings of IEEE Workshop on Nonlinear Signal and Image Processing, Neos Marmaras, Greece, June 1995. Additional descriptions of voice activity detectors may be found at U.S. Pat. No. 6,427,134 of Garner et al., U.S. Pat. No. 6,249,757 of Cason, and Lynch Jr J. F., Josenhans J. G. and Crochiere R. E. “Speech/Silence Segmentation for Real-Time Coding via Rule based Adaptive endpoint Detection,” ICASSP, pp. 31.7.1-31.7.4, 1987, all of which are incorporated by reference herein.

A significant characteristic of the first voice activity detector 130 is that it is designed to have a low miss rate—there is a very low probability to classify a noisy input signal that includes speech signal as an input signal that does not include a speech signal. A further characteristic of the first voice activity detector 130 is that it is fast and does not introduce a significant delay in the speech enhancement scheme.

Noise Estimator

Noise estimator 140 is responsive to a determination of the first voice activity detector 130 and additionally may be responsive to a determination of second voice activity detector 220.

According to an aspect of the invention noise estimator initiates a noise estimation process only if the first voice activity detector 130 indicates that the noisy input signal does not include a speech signal. This decision may be provided as a hard decision by first voice activity detector 130, or may occur when the likelihood of an existence of a speech signal in the noisy input signal exceeds a first threshold. This indication may also be provided by second voice activity detector 220.

According to another aspect of the invention the noise estimation is responsive to the soft decision of first voice activity detector 130, whereas the significance of the currently received noisy input signal (in relation to previously received noisy input signals) is responsive to the likelihood of an existence of a speech signal in the noisy input signal.

For example, assuming that first voice activity detector 130 implements an exponential averaging scheme, the value of λ_{D} is proportional to the likelihood. Yet according to another example, a set of λ_{D} are mapped to a set of likelihood value ranges, such as when the likelihood falls within on of the ranges, the corresponding λ_{D} is selected.

Noise estimator 140 outputs a spectral representation of an estimated noise signal, whereas the spectral representation includes multiple frequency components.

According to an aspect of the invention the noise estimators stores the values of frequency components of input signals that were classified as not including a speech signals. The values are stored in a memory unit that is capable of storing values of signals that were received during a predefined time period. The predefined time period exceeds the response period of second voice activity detector 220, thus allowing erroneously classified noise signals to be erased from the memory unit. In other words—if second voice activity detector 220 determines that a certain noisy input signal, that was previously defined by VAD 13 as a noise signal, does include a speech signal—the parameters of that certain noisy input signals are erased. Noise estimation 140 is able to access the stored values and to calculate the estimated noise, which is also stored in a memory unit.

According to yet another aspect of the invention the noise estimation is updates only after the second voice activity detector 200 confirm the decision of the first voice activity detector 130.

Spectral Subtracting Block

Spectral subtracting block 150 is operable to subtract the frequency components of the estimated noise signal from the frequency components of the noisy input signal to provide a rough estimate of the speech signal.

According to an aspect of the invention the spectral subtraction occurs only if first voice activity detector 130 determines that the noisy input signal includes speech signals (that the likelihood that the noisy input signal includes a speech signal exceeds a threshold).

According to another aspect of the invention the spectral subtraction is implemented for each noisy input signal, regardless the determination of the first voice activity detector 130.

Masking Threshold Calculator

The masking threshold calculator 160 is operable to compute a masking threshold per band, and for each frame. For each band and for each frame the computation includes summing the energies of frequency components of the roughly estimated speech signal that belong to the band. The summed energies undergo a convolution operation with frequency components of a spreading function that reflects the masking phenomenon. Frequency components of a relative threshold offset are subtracted from the product of the convolution. The relative threshold offset reflects the noise-like nature of speech in higher critical bands and the tone-like nature of speech in lower critical bands. The result of the subtraction is renormalization and compared to the absolute threshold of hearing, to ensure that a masking threshold does not fall below the absolute threshold of hearing in the relevant band.

According to another aspects of the invention the masking threshold calculator 160 is provided with signals other than the roughly estimated speech signal during the calculation of the optimal parameter calculation.

Optimal Parameters Calculator

Optimal parameters calculator 170 is operable to compute the subtraction parameters by various manners, some may require the optimal parameter calculator 170 to co-operate with other blocks of apparatus 100.

In general, the subtraction parameter calculation includes (i) defining the relationship between masking threshold values and subtraction parameters values and, (ii) the selection of the optimal subtraction parameter in response to the masking threshold that was calculated by the masking threshold calculator 160. Conveniently, subtraction parameters a and P are determined (for each band and for each frame) by the following equations:

αₘ=F_{α}[αₘᵢₙ,αₘₐₓ,T(ω)]

βₘ=F_{β}[βₘᵢₙ,βₘₐₓ,T(ω)]

where F_{α}=αₘₐₓ, if T(ω)=T(ω)ₘᵢₙ; Fα_{=α}ₘᵢₙ if T(ω)=T(ω)ₘₐₓ and the values of F_{α} between these two extremes are interpolated based upon the values of T(ω). The same applies for F_{β}. Both functions (F_{β} and F_{α}) may be smoothed in order to prevent discontinuities in the gain function G(ω).

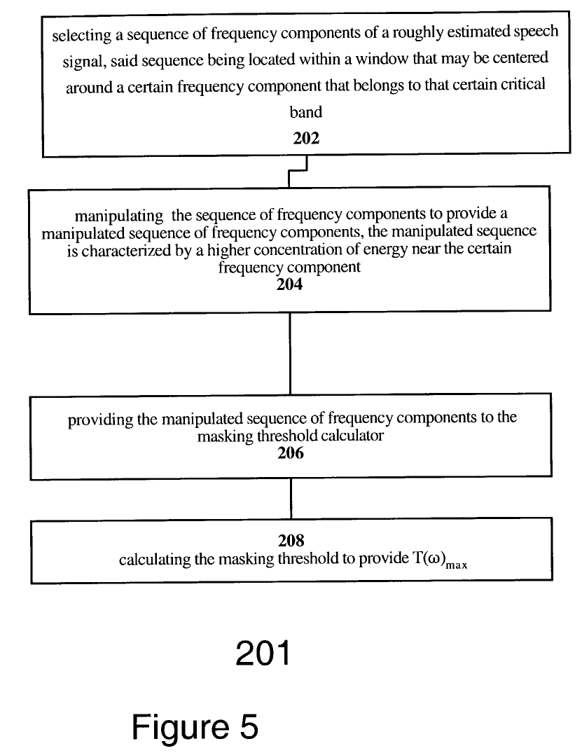

Referring to FIG. 5, illustrating a calculation of T(ω)ₘₐₓ of a certain critical band and of a certain frame, the calculation (“201”) includes the steps of: (i) selecting (step 202) a sequence of frequency components of a roughly estimated speech signal, said sequence being located within a window that may be centered around a certain frequency component that belongs to that certain critical band; (ii) manipulating (step 204) the sequence of frequency components to provide a manipulated sequence of frequency components, the manipulated sequence is characterized by a higher concentration of energy near the certain frequency component; (iii) providing (step 206) the manipulated sequence of frequency components to the masking threshold calculator, and (iv) calculating (step 208) the masking threshold to provide T(ω)ₘₐₓ

Conveniently, the manipulation involves shifting a substantial amount of intensity (about a half) to that certain frequency component from frequency components that are adjacent to the certain frequency component. Other manipulations shall take into account the masking phenomenon.

According to another aspect of the invention T(ω)ₘₐₓ is calculated in response to masking thresholds statistics that are calculated in an offline manner by an apparatus that is able to receive the clean signal (without additive noise) and calculate these statistics. After the statistics are calculated they may be downloaded to apparatus 100.

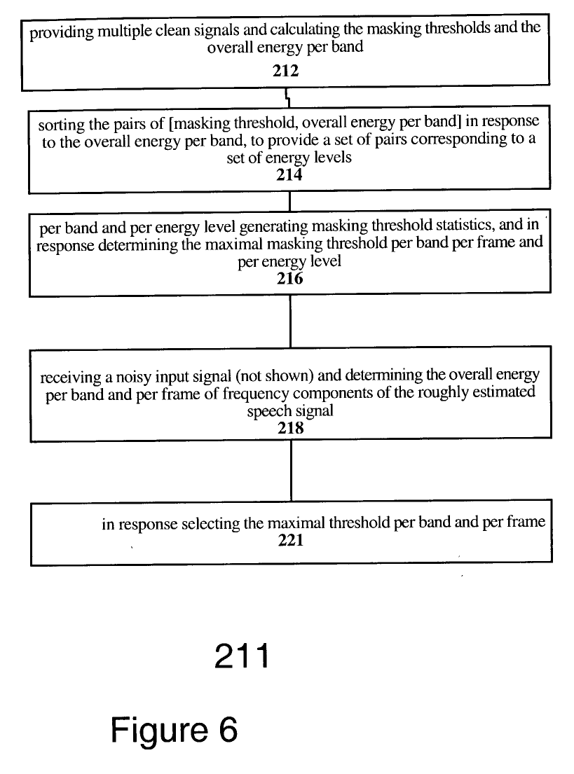

Referring to FIG. 6, illustrating a calculation of T(ω)ₘₐₓ of a certain critical band and of a certain frame, the calculation (“211”) includes off line steps and real time steps. The off line steps include: (i) providing (step 212) multiple clean signals and calculating the masking thresholds and the overall energy per band; (ii) sorting (step 214) the pairs of [masking threshold, overall energy per band] in response to the overall energy per band, to provide a set of pairs corresponding to a set of energy levels; (iii) per band and per energy level generating (step 216) masking threshold statistics, and in response determining the maximal masking threshold per band per frame and per energy level. The real time step include the steps of: receiving a noisy input signal (not shown) and determining (step 218) the overall energy per band and per frame of frequency components of the roughly estimated speech signal; and in response selecting (step 221) the maximal threshold per band and per frame.

Conveniently, the maximal masking threshold per band per frame and per energy level is calculated by the following equation:

Thₘₐₓ(Bₗ)=E[Th(Bₗ)]+n·σ[Th(Bₗ)] 1≦i≦18

n—times standard deviation.

E[Th(Bₗ)]—the mean of the thresholds at band Bₗ.

Another way of determining Thₘₐₓ(Bₗ) is by taking the upper x percentage.

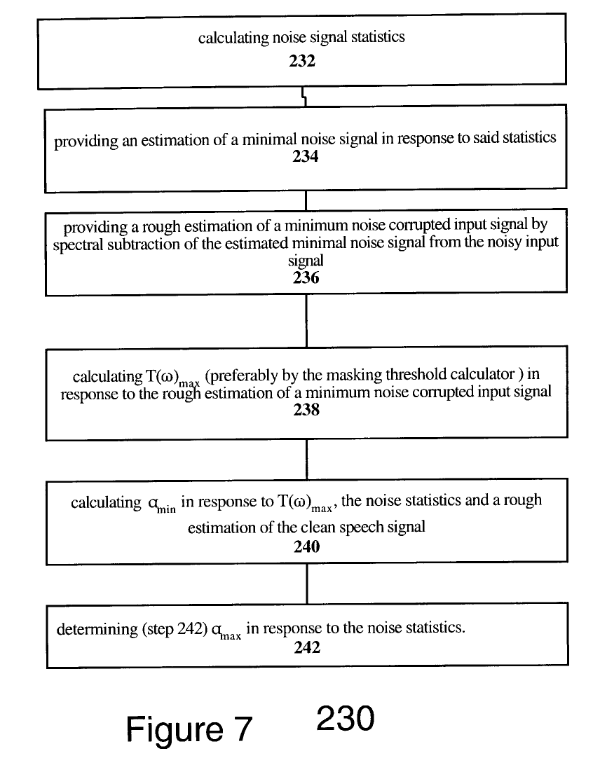

According to yet another aspect of the invention the subtraction parameters are calculated in response to the statistics of the noise signals. Referring to FIG. 7, illustrating a calculation of T(ω)ₘₐₓ of a certain critical band and of a certain frame, the calculation (“231”) includes the steps of: (i) calculating (step 232) noise signal statistics, (ii) providing (step 234) an estimation of a minimal noise signal in response to said statistics, (iii) providing (step 236) a rough estimation of a minimum noise corrupted input signal by spectral subtraction of the estimated minimal noise signal from the noisy input signal, (iv) calculating (step 238) T(ω)ₘₐₓ (preferably by the masking threshold calculator) in response to the rough estimation of a minimum noise corrupted input signal, (v) calculating (step 241) αₘᵢₙ in response to T(ω)ₘₐₓ, the noise statistics and a rough estimation of the clean speech signal, (vi) determining (step 242) αₘₐₓ in response to the noise statistics.

Conveniently, the following equations are implemented during the mentioned above calculations:

α(Bₗ)=α(Th(Bₗ),E(Bₗ),Sₙₙ(k),σₙₙ(k))

Sₙₙ(k)<Sₙₙ(k)·(1+m·σₙₙ(k)) with probability

αₘₐₓ(Bₗ)=(1+m·σₙₙ(k))

$${α}_{min} ( {B}_{i} ) = ( 1 + m \cdot {σ}_{nn} ( k ) ) - \frac{{Th}_{max} ( {B}_{i} ) \cdot {S}_{xx} ( k )}{{S}_{nn} ( k )}$$

Sₙₙ^{min}(k)=max(Sₙₙ(k)·(1−m·σₙₙ(k)),0)

whereas: Sₓₓ(k)—The clean speech power spectral density that is roughly estimated by the rough SS block, variable m is parameter that preferably ranges between 1 and 6, the short-term noise power spectral density at each frequency component is σ(Sₙₙ(k))

$$σ ( {S}_{nn} ( k ) ) {=}^{Δ} {σ}_{nn} ( k )$$

and the energy of each critical band is E(Bₗ).

It is further noted that subtraction parameter β may be calculated by various manners. The inventors have found that the minimal value of β (βₘᵢₙ) should be 0.25 while the maximal value of β (βₘₐₓ) should be 0.45, but this is not necessarily so.

According to another aspect of the invention a may be predefined. The inventors have found that the following values a of may be useful: αₘₐₓ=4 and αₘᵢₙ=1.

Parametric Subtracting Block

The parametric subtracting block 180 includes multiple filters, each filter corresponds to a single predefined frequency component. The filters that correspond to the same critical band use the same subtraction parameters α and β. A frequency component of the noisy input signal is filtered by a filter that corresponds to that frequency components.

For example, referring to table 1, the first frequency component filter will filter the first frequency component of the noisy input signal, the second frequency component filter will filter the second frequency component of the noisy input signal. As both frequency components belong to the first critical band, the subtraction parameters of both filters will be the same.

Conveniently, each filter implements the following gain equation:

$$H ( k , m ) = max \{ \sqrt{1 - \frac{α ( k , m ) \cdot Snn ( k , m )}{Syy ( k , m )}} , β ( k , m ) \}$$

whereas k denotes the frequency component identifier and m the frame identifier.

Signal to Noise Estimator

Signal to noise estimator 190 determines whether the noisy input signal includes a speech signal in response to the ratio between the overall power of the noisy input signal and the overall power of the estimated noise signal. Conveniently, the noise estimator provides an estimation of the power spectral density of the noise, while the noisy input signal components must be further processed to provide the power spectral density of the noisy input signal.

The signal to noise estimator is conveniently operable to provide a hard decision (“cancel musical noise”) for initiating a musical noise cancellation process, if the ratio exceeds a second predefined threshold.

Musical Noise Suppressor

The output of the parametric subtracting block 180 is connected to the input of the musical noise suppressor 200 for providing an intermediate signal to the musical noise suppressor 200. The intermediate signal is further processed by musical noise suppressor 200 in response to the “cancel musical noise” from signal to noise estimator 190.

When a “cancel musical noise” signal is received from signal to noise estimator 190 musical noise suppressor 200 initiates a smoothing operation by limiting at least one characteristic of the frequency component of the intermediate signal.

According to an aspect of the invention the limiting process performs a smoothing operation by limiting the intensity of a frequency component of the intermediate signal in response to the intensity of other frequency components of the intermediate signal. Conveniently, the limiting operation is responsive to the statistics of a sequence of consecutive frequency components, said sequence is centered around the frequency component that may be intensity limited. The sequence is determined by a predefined window that is usually much shorter then length (amount of frequency components) of the FFT converted frame. In order to process all the frequency components of the FFT converted frame, the window “slides” to define a partially overlapping new sequence of consecutive frequency components. The inventors found that using a sliding window of eleven frequency components length, and a overlapping of nine frequency components is very effective.

Preferably, the maximal intensity does not exceed the sum of: (i) the spectral intensity average, and (ii) a standard deviation of these intensities. The maximal intensity may be limited according to other statistically based rules.

WOLA Synthesizer

WOLA synthesizer 210 “inverts” the operation of the WOLA analyzer. It converts the 128 frequency components to a time domain frame of 256 samples. Briefly, the 128 frequency components are converted to time domain frame of 128 elements by an inverse Discrete Fourier Transform. The 128-long frame is duplicated to form a 256-long frame. The 256-longh frame is multiplied by a Hanning window to provide a 256-long filtered frame. The 256-long filtered frame is added to a content of a buffer to provide a 256-long sum frame. The sixty-four most significant elements of the 256-long sum frame are provided as an output of the WOLA synthesizer 210, whereas the content of the buffer is shifted left by sixty-four digits, and padded with zeroes.

Low Pass Filter

The low pass filter 230 suppresses high frequency components of musical noise signals that are outputted by WOLA synthesizer 210. This suppression aids to reduce the perception of musical noise, as the masking is higher at lower frequencies and as human auditory system is more sensitive to the higher frequency components (2 kHz-4 KHz) of that musical noise. It is noted that this low pass filter can also be located before the WOLA synthesizer 210.

Second Voice Activity Detector

Second voice activity detector 220 detects speech/non-speech in order to validate the hypothesis posted previously by the first voice activity detector 130. The second voice activity detector 220 decision enables the adaptation of the first voice activity detector 130 metrics upon detecting non-speech. It is important to have robust decision of non-speech, for enabling voice activity detector adaptation, since detecting a speech frame, as non-speech (miss), will implicitly updates voice activity detector badly. That is to say that the voice activity detector will learn speech characteristics as if they were noise ones which will be harmful. Once the voice activity detector's metric adaptation is enabled, the adaptation manner is determined by its previous soft decision.

The second voice activity detector based noise suppressor minimizes the effect of musical tones that are more audible in non-speech periods than in speech ones. To mitigate the effect of switching the suppressor on and off, smooth transitions from suppress state to no-suppress state using a decay and attack times are provided.

A typical second voice activity detector is characterized by its maximal suppression, its decay period and attack period. The decay period is defined as the time period that elapsed from speech to no-speech transition, while the attack period is defined as the time period that elapsed from speech to not-speech transition. The decay period is long (about 500-1000 ms) while the attack time is short (about 5-50 ms).

Output Suppressor

Output suppressor 240 operates in the time domain and operable to reduce the overall of power of the output signal of apparatus 100. Output suppressor 240 is especially operative to strongly suppress output signals that were classified by second voice activity detector 220 as noise. It is noted that the output suppressor 240 may implement a more complicated suppression scheme, such as to alter the suppression in response to a transition of the second voice activity detector 220 output from noise to speech and vice versa.

Speech Enhancement Methods

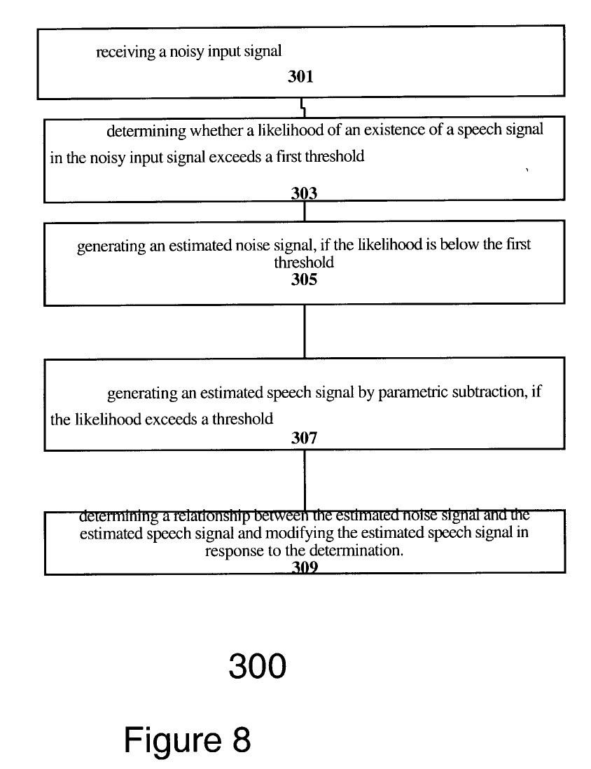

FIG. 8 illustrates a first method 300 for speech enhancement, the method includes the following steps: (i) step 301 of receiving a noisy input signal; (ii) step 303 of determining whether a likelihood of an existence of a speech signal in the noisy input signal exceeds a first threshold; (iii) step 305 of generating an estimated noise signal, if the likelihood is below the first threshold; (iv) step 307 of generating an estimated speech signal by parametric subtraction, if the likelihood exceeds a threshold; and (v) step 309 of determining a relationship between the estimated noise signal and the estimated speech signal and modifying the estimated speech signal in response to the determination.

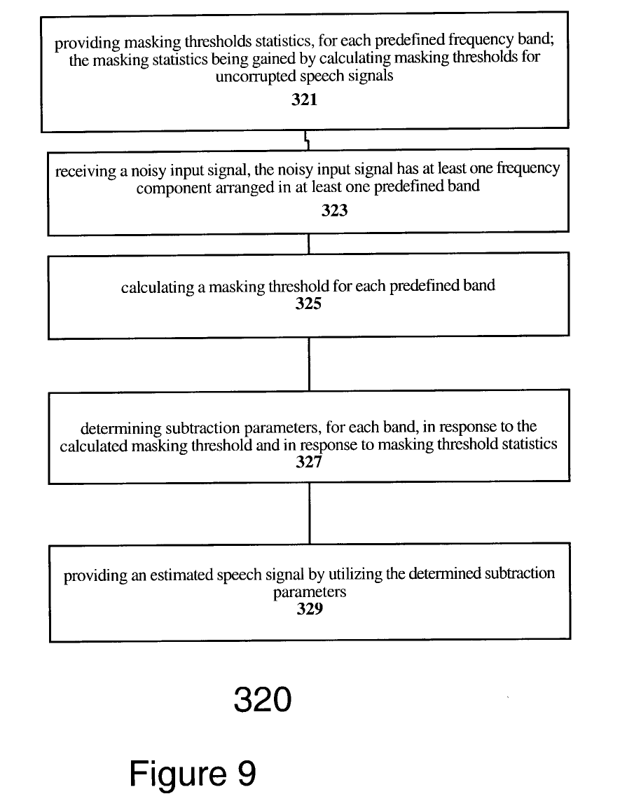

FIG. 9 illustrates a second method 320 for speech enhancement, the method includes the following steps: (i) step 321 of providing masking thresholds statistics, for each predefined frequency band; the masking statistics being gained by calculating masking thresholds for uncorrupted speech signals; (ii) step 323 of receiving a noisy input signal, the noisy input signal has at least one frequency component arranged in at least one predefined band; (iii) step 325 of calculating a masking threshold for each predefined band; (iv) step 327 of determining subtraction parameters, for each band, in response to the calculated masking threshold and in response to masking threshold statistics; and (v) step 329 of providing an estimated speech signal by utilizing the determined subtraction parameters.

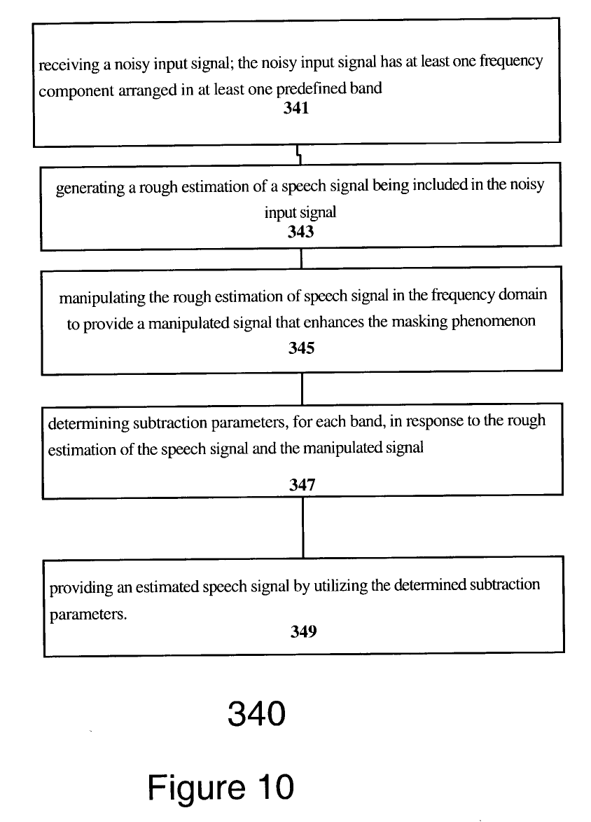

FIG. 10 illustrates a third method 340 for speech enhancement, the method includes the following steps The invention provides a method for speech enhancement, the method includes the steps of: (i) step 341 of receiving a noisy input signal; the noisy input signal has at least one frequency component arranged in at least one predefined band; (ii) step 343 of generating a rough estimation of a speech signal being included in the noisy input signal; (iii) step 345 of manipulating the rough estimation of speech signal in the frequency domain to provide a manipulated signal that enhances the masking phenomena; (iv) step 347 of determining subtraction parameters, for each band, in response to the rough estimation of the speech signal and the manipulated signal; and (v) step 349 of providing an estimated speech signal by utilizing the determined subtraction parameters.

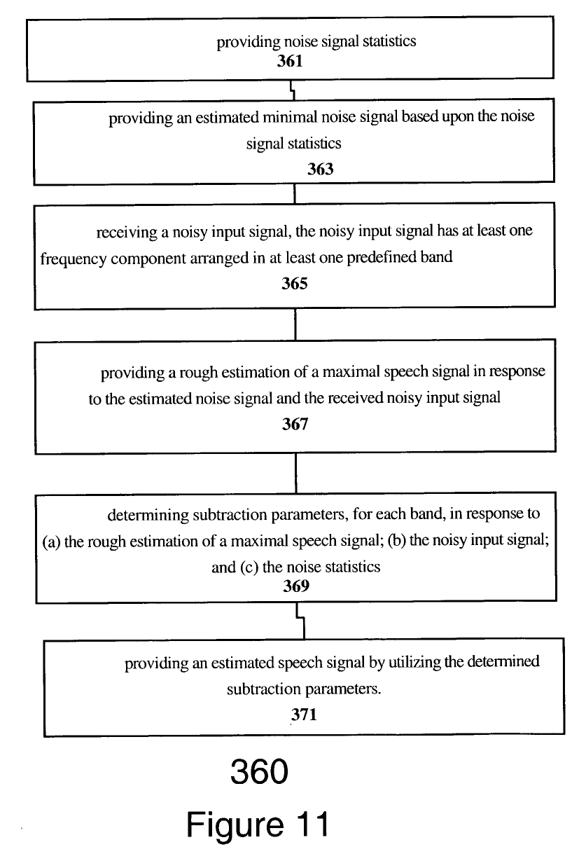

FIG. 11 illustrates a fourth method 360 for speech enhancement, the method includes the following steps: (i) step 361 of providing noise signal statistics; (ii) step 363 of providing an estimated minimal noise signal based upon the noise signal statistics; (iii) step 365 of receiving a noisy input signal, the noisy input signal has at least one frequency component arranged in at least one predefined band; (iv) step 367 of providing a rough estimation of a maximal speech signal in response to the estimated noise signal and the received noisy input signal; (v) step 369 of determining subtraction parameters, for each band, in response to (a) the rough estimation of a maximal speech signal; (b) the noisy input signal; and (c) the noise statistics; and (vi) step 371 of providing an estimated speech signal by utilizing the determined subtraction parameters.

Those skilled in the art will readily appreciate that various modifications and changes may be applied to the preferred embodiments of the invention as hereinbefore exemplified without departing from its scope as defined in and by the appended claims.

What is claimed is:

1. A method for speech enhancement, the method comprising the steps of:
receiving a noisy input signal;
determining whether a likelihood of an existence of a speech signal in the noisy input signal exceeds a first threshold;
generating an estimated noise signal, if the likelihood is below the first threshold;
generating an estimated speech signal by parametric subtraction, if the likelihood exceeds a threshold; and
determining a relationship between the estimated noise signal and the estimated speech signal and modifying the estimated speech signal in response to the determination.

2. The method of claim 1 wherein the relationship reflects a ratio between a power of the estimated noise signal and a power of the estimated speech signal.

3. The method of claim 2 wherein the estimated speech signal is modified if the ratio exceeds a predefined power threshold.

4. The method of claim 1 wherein the modifying includes smoothing of the estimated speech signal.

5. The method of claim 1 wherein the modifying includes modifying an intensity of a frequency component of the estimated speech signal in response to intensities of other frequency components of the estimated speech signal.

6. The method of claim 1 further comprising the a preliminary step of providing masking thresholds statistics, for each predefined frequency band; the masking statistics being gained by calculating masking thresholds for uncorrupted speech signals.

7. The method of claim 6 wherein the step of generating an estimated speech signal by parametric subtraction, comprising the steps of:
calculating a masking threshold for each predefined band;
determining subtraction parameters, for each band, in response to the calculated masking threshold and in response to masking threshold statistics; and
providing an estimated speech signal by utilizing the determined subtraction parameters.

8. The method of claim 1 wherein the step of generating an estimated speech signal by parametric subtraction comprising:
generating a rough estimation of a speech signal being included in the noisy input signal;
manipulating the rough estimation of speech signal in the frequency domain to provide a manipulated signal that enhances the masking phenomena;
determining subtraction parameters, for each band, in response to the rough estimation of the speech signal and the manipulated signal; and
providing an estimated speech signal by utilizing the determined subtraction parameters.

9. The method of claim 1 further comprising the steps of providing noise signal statistics and providing an estimated minimal noise signal based upon the noise signal statistics.

10. The method of claim 10 wherein the step of generating an estimated speech signal by parametric subtraction comprising: providing a rough estimation of a maximal speech signal in response to the estimated noise signal and the received noisy input signal; determining subtraction parameters, for each band, in response to (i) the rough estimation of a maximal speech signal; (ii) the noisy input signal; and (ii) the noise statistics; and providing an estimated speech signal by utilizing the determined subtraction parameters.

11. The method of claim 1 further comprising a step of high pass filtering the noisy input signal after receiving the noisy input signal.

12. The method of claim 1 further comprising a step of low pass filtering the estimated speech signal.

13. The method of claim 1 further comprising a step examining the estimated speech signal to detect speech signal and suppressing the estimated speech signal in response to the detection.

14. The method of claim 1 wherein the subtraction parameters comprise α, β, γ1, and γ2.

15. The method of claim 14 wherein γ1 equals 2 and γ2 equals 0.5.

16. The method of claim 14 wherein β ranges between 0.25 and 0.45.

17. The method of claim 14 wherein subtraction parameter α is determined per frame of frequency components of the noisy input signal and per critical band.

18. A method for speech enhancement, the method comprising the steps of:
providing masking thresholds statistics, for each predefined frequency band; the masking statistics being gained by calculating masking thresholds for uncorrupted speech signals;
receiving a noisy input signal, the noisy input signal has at least one frequency component arranged in at least one predefined band;
calculating a masking threshold for each predefined band;
determining subtraction parameters, for each band, in response to the calculated masking threshold and in response to masking threshold statistics; and
providing an estimated speech signal by utilizing the determined subtraction parameters.

19. The method of claim 18 further comprising the step of determining a relationship between the estimated noise signal and the estimated speech signal and modifying the estimated speech signal in response to the determination.

20. The method of claim 18 further comprising a step of high pass filtering the noisy input signal after receiving the noisy input signal.

21. The method of claim 18 further comprising a step of low pass filtering the estimated speech signal.

22. The method of claim 18 further comprising a step examining the estimated speech signal to detect speech signal and suppressing the estimated speech signal in response to the detection.

23. The method of claim 18 wherein the subtraction parameters comprise α, β, γ1, and γ2.

24. The method of claim 23 wherein γ1 equals 2 and γ2 equals 0.5.

25. The method of claim 23 wherein β ranges between 0.25 and 0.45.

26. A method for speech enhancement, the method comprising the steps of:
receiving a noisy input signal; the noisy input signal has at least one frequency component arranged in at least one predefined band;
generating a rough estimation of a speech signal being included in the noisy input signal;
manipulating the rough estimation of speech signal in the frequency domain to provide a manipulated signal that enhances the masking phenomena;
determining subtraction parameters, for each band, in response to the rough estimation of the speech signal and the manipulated signal; and
providing an estimated speech signal by utilizing the determined subtraction parameters.

27. The method of claim 26 further comprising the step of determining a relationship between the estimated noise signal and the estimated speech signal and modifying the estimated speech signal in response to the determination.

28. The method of claim 26 further comprising a step examining the estimated speech signal to detect speech signal and suppressing the estimated speech signal in response to the detection.

29. The method of claim 26 wherein the subtraction parameters comprise α, β, γ1, and γ2.

30. The method of claim 31 wherein γ1 equals 2 and γ2 equals 0.5.

31. The method of claim 31 wherein β ranges between 0.25 and 0.45.

32. A method for speech enhancement, the method comprising the steps of:
providing noise signal statistics;
providing an estimated minimal noise signal based upon the noise signal statistics;
receiving a noisy input signal, the noisy input signal has at least one frequency component arranged in at least one predefined band;
providing a rough estimation of a maximal speech signal in response to the estimated noise signal and the received noisy input signal;
determining subtraction parameters, for each band, in response to (i) the rough estimation of a maximal speech signal; (ii) the noisy input signal; and (ii) the noise statistics; and
providing an estimated speech signal by utilizing the determined subtraction parameters.

33. The method of claim 34 further comprising the step of determining a relationship between the estimated noise signal and the estimated speech signal and modifying the estimated speech signal in response to the determination.

34. The method of claim 34 wherein the subtraction parameters comprise α, β, γ1, and γ2.

35. The method of claim 36 wherein γ1 equals 2 and γ2 equals 0.5.

36. The method of claim 36 wherein β ranges between 0.25 and 0.45.

37. A computer readable medium having code embodied therein for causing an electronic device to perform the steps of:
receiving a noisy input signal;
determining whether a likelihood of an existence of a speech signal in the noisy input signal exceeds a first threshold;
generating an estimated noise signal, if the likelihood is below the first threshold;
generating an estimated speech signal by parametric subtraction, if the likelihood exceeds a threshold; and
determining a relationship between the estimated noise signal and the estimated speech signal and modifying the estimated speech signal in response to the determination.

38. A computer readable medium having code embodied therein for causing an electronic device to perform the steps of:
providing masking thresholds statistics, for each predefined frequency band; the masking statistics being gained by calculating masking thresholds for uncorrupted speech signals;
receiving a noisy input signal, the noisy input signal has at least one frequency component arranged in at least one predefined band;
calculating a masking threshold for each predefined band;
determining subtraction parameters, for each band, in response to the calculated masking threshold and in response to masking threshold statistics; and
providing an estimated speech signal by utilizing the determined subtraction parameters.

39. A computer readable medium having code embodied therein for causing an electronic device to perform the steps of:
providing noise signal statistics;
providing an estimated minimal noise signal based upon the noise signal statistics;
receiving a noisy input signal, the noisy input signal has at least one frequency component arranged in at least one predefined band;
providing a rough estimation of a maximal speech signal in response to the estimated noise signal and the received noisy input signal;
determining subtraction parameters, for each band, in response to (i) the rough estimation of a maximal speech signal; (ii) the noisy input signal; and (ii) the noise statistics; and
providing an estimated speech signal by utilizing the determined subtraction parameters.

40. A computer readable medium having code embodied therein for causing an electronic device to perform the steps of:
receiving a noisy input signal; the noisy input signal has at least one frequency component arranged in at least one predefined band;
generating a rough estimation of a speech signal being included in the noisy input signal;
manipulating the rough estimation of speech signal in the frequency domain to provide a manipulated signal that enhances the masking phenomena;
determining subtraction parameters, for each band, in response to the rough estimation of the speech signal and the manipulated signal; and
providing an estimated speech signal by utilizing the determined subtraction parameters.

41. An apparatus for speech enhancement, the apparatus comprising:
a frequency converter, operable to generate a spectral representation of a noisy input signal;
a first voice activity detector, coupled to the frequency converter, operable to determine whether a likelihood of an existence of a speech signal in the noisy input signal exceeds a first threshold;
a noise estimator, coupled to the first voice activity detector, for generating an estimated noise signal, if the likelihood is below the first threshold;
a parametric subtraction entity, coupled to the noise estimator and the frequency converter, operable to generate an estimated speech signal by parametric subtraction, if the likelihood exceeds a threshold;
a signal to noise estimator, coupled to the noise estimator and to the frequency converter, operable to determine a relationship between the estimated noise signal and the estimated speech signal; and
a musical noise suppressor, coupled to the signal to noise estimator, for modifying the estimated speech signal in response to the determination.

42. The apparatus of claim 37 wherein the parametric subtraction entity comprises a spectral subtraction block, a masking threshold calculator, an optimal parameters calculator and a parametric subtraction block.2.
